(19) United States
(12) Patent Application Publication
(10) Pub. No.: US 2014/0302190 A1
(43) Pub. Date: Oct. 9, 2014

(54) MOLDING ROLLER AND METHOD OF MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/067,948

(22) Filed: Oct. 31, 2013

(30) Foreign Application Priority Data
Apr. 3, 2013 (TW) 102112073

(51) Int. Cl. B29C 33/38

(52) U.S. Cl. CPC B29C 33/3878; B29L 2031/757
USPC 425/385; 264/226

(57) ABSTRACT

A molding roller includes a roller body and a molding film. The roller body includes a cylindrical surface. The molding film is sprayed on the cylindrical surface and includes a molding surface facing away from the cylindrical surface. A micro-structure pattern is formed on the molding surface. The molding film is made of a polymer material including PDMS.

### BACKGROUND

1. Technical Field

The present disclosure relates to molding devices, and particularly to a molding roller and a method of manufacturing the molding roller.

2. Description of Related Art

Molding rollers generally include a roller body and a copper layer coated on an outer cylindrical surface of the roller body. A micro-structure pattern is formed on the copper layer for molding an optical element, such as a brightness enhancement film. However, when a part of the micro-structure pattern of the copper layer is damaged, the entire copper needs to be replaced, which increases a cost of the molding roller.

Therefore, it is desirable to provide a molding roller and a method of manufacturing the molding roller to overcome the limitations described.

### BRIEF DESCRIPTION OF THE DRAWINGS

FIG. 1 is an isometric view of a molding roller in accordance with an exemplary embodiment.

FIG. 2 is a pictural flowchart of a method of manufacturing the molding roller of FIG. 1.

### DETAILED DESCRIPTION

Embodiments of the disclosure will be described with reference to the drawings.

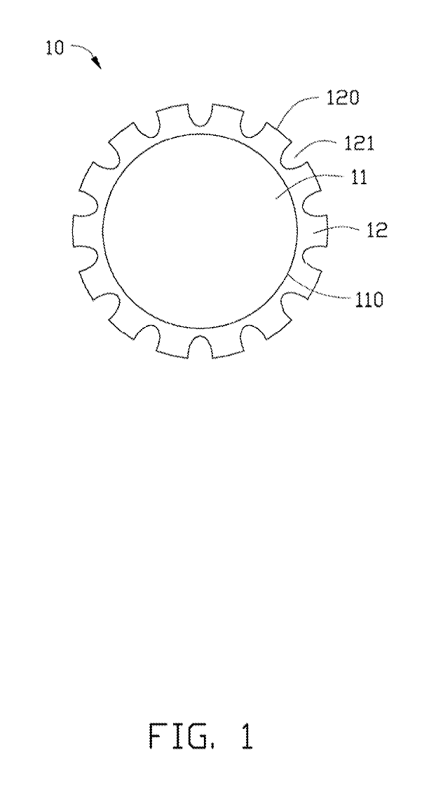

FIG. 1 shows a molding roller 10, which is used to mold an optical element (not shown), such as a brightness enhancement film. The molding roller 10 includes a roller body 11 and a molding film 12.

The roller body 11 is substantially cylindrical and includes a cylindrical surface 110. The roller body 11 is made of metal, such as copper, and a Mohs hardness of the roller body 11 is greater than about 2.5. In the embodiment, in order to improve an adhesive force of the cylindrical surface 110, the cylindrical surface 110 is roughened by a roughing process.

The molding film 12 is coated on the cylindrical surface 110 and forms an annular tube sleeved on the roller body 11. The molding film 12 includes a molding surface 120 facing away from the cylindrical surface 110. A thickness of the molding film 12 is from about 100 millimeters (mm) to about 150 mm. A micro-structure pattern 121 is formed on the molding surface 120 for forming the optical element. The molding film 12 is made of a flexible high-polymer material including polydimethylsiloxane (PDMS). The chemical formula of PDMS is CH₃[Si(CH₃)₂O]ₙSi(CH₃)₃, where n is the number of repeating [Si(CH₃)₂O] monomer units. The PDMS has a good bonding resistance with a resin of the optical element, which makes the molding film 12 easily separate from the optical element.

In the embodiment, the thickness of the molding film 12 is uniform. The molding film 12 is formed on the entire cylindrical surface 110. A length of the molding film 12 is substantially equal to a length of the roller body 11. The micro-structure pattern 121 includes a number of recesses defined in the molding surface 120.

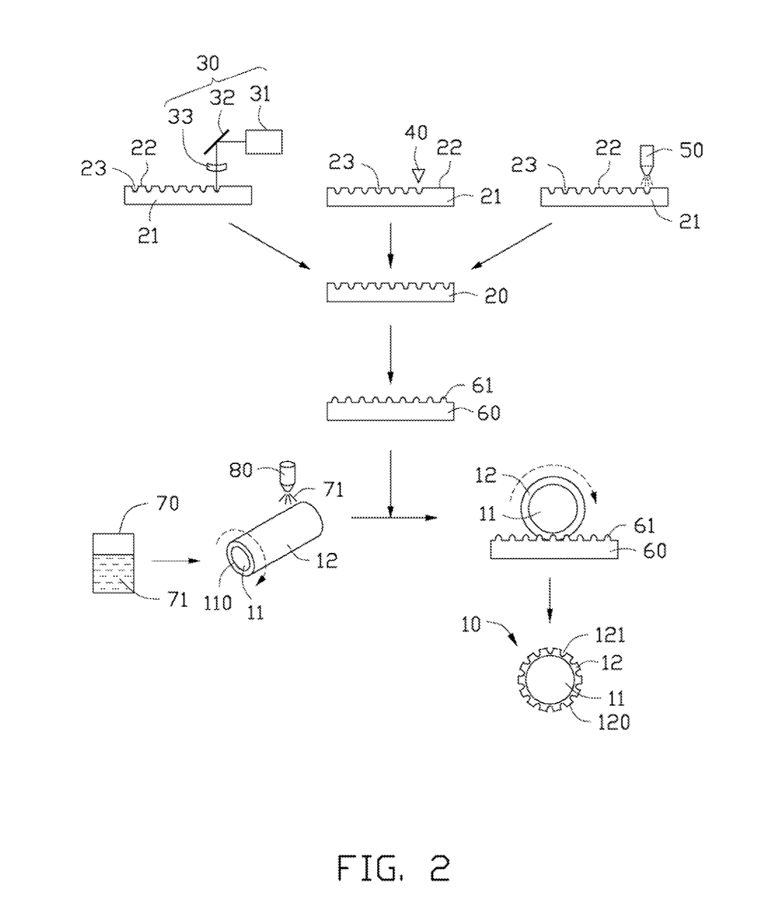

FIG. 2 shows a method of manufacturing the molding roller 10, according to an exemplary embodiment. The method includes steps S101-S106.

S101: a mother mold 20 is provided. The mother mold 20 includes a base 21 and a processing pattern 22 defined on an upper surface of the base 21. The mother mold 20 is substantially plate-shaped and is made of copper. A width of the mother mold 20 is substantially equal to a circumference of the roller body 11, and a length of the mother mold 20 is substantially equal to a length of the roller body 11. The mother mold 20 can be manufactured by laser-etching, precision-machining, or sand-blasting. The processing pattern 22 includes a number of recesses defined in the base 21.

When the mother mold 20 is manufactured by laser-etching, the processing pattern 22 is etched by a laser emitted from a laser device 30. The laser device 30 includes a laser source 31, a reflecting lens 32, and a focusing lens 33. The reflecting lens 32 reflects the laser beam emitted from the laser source 31 onto the focusing lens 33. The focusing lens 33 focuses the laser beam onto the mother mold 20. As the laser device 30 is moved, the processing pattern 22 is etched onto the mother mold 20.

When the mother mold 20 is manufactured by precision-machining, the processing pattern 22 is machined by a tool 40. The tool 40 is controlled by a computer numerical control (CNC) system. As the tool 40 moves, the processing pattern 22 is machined onto the mother mold 20.

When the mother mold 20 is manufactured by sand-blasting, the processing pattern 22 is processed by a blasting device 50. A mask is positioned between the blasting device 50 and the base 21, and a part of the base 21 to be processed is exposed out of the mask.

S102: a transferring mold 60 having a transferring print pattern 61 is provided. A layer of metal is electroformed on the processing pattern 22 of the mother mold 20 to form a transferring mold 60. The mother mold 20 is removed from the transferring mold 60 by laser etching. As a result, the transferring print pattern 61 corresponding to the processing pattern 22 is formed on the transferring mold 60. A size and a shape of the transferring mold 60 are the same as a size and a shape of the mother mold 20. The transferring print pattern 61 includes a number of protrusions formed on the transferring mold 60.

S103: a PDMS solution 71 is provided. The PDMS solution 71 is made by mixing the PDMS with a curing agent in a proportion from about 10:1 to about 15:1. The PDMS and the curing agent are mixed in a receiver 70, and the PDMS is uniformly mixed with the curing agent. The curing agent is an ethylenediamine.

It is understand that the PDMS solution 71 can be provided before the transferring mold 60 is manufactured.

S104: the PDMS solution 71 is sprayed on the cylindrical surface 110 of the roller body 11 to form a molding film 12. The roller body 11 is rotated, and the PDMS solution 71 is sprayed on the entire cylindrical surface 110 by a spraying device 80, thereby forming the molding film 12 on the roller body 11. The thickness of the molding film 12 is uniform and can be controlled by adjusting the rotation speed of the roller body 11 and the spraying quantity of the spraying device 80. A thickness of the molding film 12 is from about 100 millimeters (mm) to about 150 mm.

S105: the transfer printing pattern 61 of the transferring mold 60 is transferred onto the molding film 12 to form the micro-structure pattern 121 on the roller body 11 by rolling the roller body 11 once over the transferring mold 60. The micro-structure pattern 121 includes a number of recesses defined in the molding film 12.

S106: the micro-structure pattern 121 of the molding roller 10 is solidified by placing the molding roller 10 in an oven having a temperature from about 25 degrees Celcius ( ) to about 100.

In the embodiment, since the micro-structure pattern 121 is transferred onto the molding film 12 sprayed on the roller body 11, the manufacturing process of the molding roller 10 is simplified.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a roller body comprising a cylindrical surface; and
a molding film coated on the cylindrical surface, and comprising a molding surface facing away from the cylindrical surface and a micro-structure pattern formed on the molding surface;
wherein the molding film is made of polymer material comprising a polydimethylsiloxane (PDMS).

2. The molding roller of claim 1, wherein a thickness of the molding film is uniform.

3. The molding roller of claim 1, wherein a thickness of the molding film is from about 100 mm to about 150 mm.

4. The molding roller of claim 1, wherein the molding film is formed on the entire cylindrical surface, and a length of the molding film is substantially equal to a length of the roller body.

5. A method of manufacturing a molding roller, comprising:
providing a transferring mold having a transferring print pattern;
providing a PDMS solution and a roller body;
spraying the PDMS on a cylindrical surface of the roller body to form a molding film;
transferring the transfer printing pattern of the transferring mold on the molding film to form a micro-structure pattern; and
solidifying the micro-structure pattern.

6. The method of claim 5, wherein the PDMS solution is made by mixing the PDMS with a curing agent in a proportion of about 10:1 to about 15:1.

7. The method of claim 5, wherein the transferring mold rolls over a mother mold, and the transferring print pattern is printed by a processing pattern of the mother mold.

8. The method of claim 5, wherein the micro-structure pattern is solidified under a temperature from about 25 to about 100 .

9. The method of claim 5, wherein a thickness of the molding film is from about 100 mm to about 150 mm.
